(19) United States
(12) Patent Application Publication
(10) Pub. No.: US 2005/0118942 A1
(43) Pub. Date: Jun. 2, 2005

(54) Coin/token dispenser

(76) Inventor: Katsumi Sugai, Nagoya-shi (JP)

Correspondence Address: MERCHANT & GOULD PC, P.O. BOX 2903, MINNEAPOLIS, MN, 55402-0903, US

(21) Appl. No.: 10/493,833

(22) PCT Filed: Dec. 12, 2003
(86) PCT No.: PCT/JP03/16009

(51) Int. Cl. G07D 1/00

(52) U.S. Cl. 453/44

(57) ABSTRACT

A coin stacker 2 has a back surface supported in a main case 3 by a support plate 32, behind which electromagnetic solenoids 41 are disposed so that solenoid plungers 43 move in generally up-and-down directions along the support plate 32. A horizontal shaft 45 pivotally supports link members 44, each having an end connected to one of the plungers 43 and another end connected to a base of a pusher 20. A coil spring 51 urges the pusher 20 onto an upper surface of the regulating groove 52 of the base member 12. The electromagnetic solenoid 41 moves forward the pusher 20 along a passage 17 between a pair of forward-facing supports 15 in the base member 12, thereby pushing a coin/token located at the lowest position in a stack of coins/tokens and supported by the pair of forward-facing supports 15, out into a shoot 5 disposed beneath the front of the main case 3, to the outside.

### TECHNICAL FIELD

The present invention relates to coin/token dispensers incorporated in automatic vending machines, fair adjusting machines and soon, for on-demand dispensing of coins or tokens (hereinafter simply called coins) from stacks of coins of a variety of kinds.

### BACKGROUND ART

Conventionally, as disclosed in the U.S. Pat. Nos. 5,797,476, 5,853,322, and 5,830,055, a coin dispenser of this kind has a main body including a detachable coin stacker which holds stacks of coins of different kinds. The coin stacker holds the coins in an array of tall and upright holders each holding a stack of coins of one kind. Each holder has a bottom end formed with a dispensing port from which the coins can be dispensed one by one.

The dispenser main body also includes a dispensing mechanism disposed near the dispensing port of the coin stacker for operation under “Dispense change” commands from a computer or other arithmetic operator. The dispenser main body further includes a shoot. The coins pushed out by the dispensing mechanism are guided by the shoot to a cup-shaped coin sump which is provided e.g. on a side of the dispenser main body.

According to the U.S. Patent Publication No. 5,830,055, the dispensing mechanism which operates on “Dispense change” commands is on the back side of the coin stacker when the coin stacker is mounted. The dispensing mechanism includes an actuator provided by an electromagnetic solenoid. The electromagnetic solenoid incorporates a linearly-moving plunger which moves in two horizontal directions, i.e. a forward pushing-out direction and a rearward direction. When the electromagnetic solenoid is activated to move the plunger in the forward pushing-out direction, the plunger pushes a coin at the bottom of a corresponding stack of the coins, in the forward direction, out of the dispensing port of the coin stacker. The shoot, which is slanted, right ahead and below the coin stacker, guides the discharged coin into a cup-shaped coin sump out of the dispenser main body.

In the above dispenser, in order for the plunger to be able to push out a coin as well as for the plunger front end to come back to behind the next coin to be pushed out of the stack, the plunger has to have a traveling stroke (traveling distance) in the push-and-retract (traveling) directions which is larger than the largest of diameters of the coins. Unavoidably therefore, there is a need for an electromagnetic solenoid capable of giving a traveling stroke large enough in the push-and-retract (traveling) directions. The electromagnetic solenoid must be placed near the bottom of the upright coin stacker, and in line with the coin discharging direction (perpendicularly to the coin stacking direction), sacrificing a long space. This layout ends up with a large dimension in the depth of the dispenser main body, specifically in the depth of a lower portion than where the coin stacker is mounted. (In other words, the dimension is inconveniently large in a direction perpendicular to the array of coin holders in the coin stacker and perpendicular to the coin stacking direction, i.e. in the direction where the coins are dispensed.)

When placing such a coin dispenser on a counter space, there is a problem that the coin dispenser limits the use of greater counter space.

### OBJECT OF THE INVENTION

The present invention was made in order to solve the above problem, and it is therefore a primary object of the present invention to provide a compact coin dispenser for effective use of counter space.

Another object is to provide a long pushing stroke for the coins, through the use of a short-stroke electromagnetic solenoid.

Still another object is to improve on positioning accuracy of a pusher which dispenses coins one by one at a lower end of the coin holder.

### DISCLOSURE OF THE INVENTION

A first aspect to accomplish the above-mentioned objects provides a coin/token dispenser including: a main case having a front surface; a coin stacker detachably mounted to the front surface for holding a stack of coins; and a dispensing mechanism incorporated in the main case for dispensing the coins from a lower end of the coin stacker out of the dispenser through a shoot. The dispensing mechanism includes an actuator disposed on a back side of a support plate of the main case which supports a back surface of the coin stacker. The actuator moves in up-and-down directions along the support plate, moving a pusher generally along a lower base portion of the coin stacker, and causing the pusher to push one of the coins out of the lower base portion of the coin stacker. The actuator is provided by an electromagnetic solenoid. The electromagnetic solenoid includes a plunger moving generally in up-and-down directions along the support plate.

A second aspect provides the dispenser, wherein the dispensing mechanism includes the pusher and a link connecting to the plunger of the electromagnetic solenoid. The pusher is movable back and forth along a guide formed in the support plate, and the link has an intermediate portion pivotably supported by a horizontal shaft.

A third aspect provides the dispenser, wherein the dispensing mechanism further includes an urger for urging the plunger in a protruding direction. The lower base portion of the coin stacker has a passage for the pusher to travel through, and a regulator regulating a vertical position of the pusher. Further, the urger urges the pusher onto the regulator.

### BRIEF DESCRIPTION OF THE DRAWINGS

FIG. 1 is a perspective view of a dispenser according to the present invention;

FIG. 2 is a front view thereof, with partial cutout;

FIG. 3(a) is a sectional view taken in lines IIIa-IIIa in FIG. 2;

FIG. 3(b) is a sectional view showing a primary portion of a coin stacker positioning support;

FIG. 4 is a front view of the coin stacker;

FIG. 5 is a rear view of the coin stacker;

FIG. 6 is a side view, with partial cutout, of the coin stacker standing separately;

FIG. 7 is a sectional view showing a primary portion of a dispensing mechanism;

FIG. 8(a) is a view taken in lines VIIIa-VIIIa in FIG. 7;

FIG. 8(b) is a view taken in lines VIIIb-VIIIb in FIG. 8(a); and

FIG. 8(c) is a view taken in lines VIIIc-VIIIc in FIG. 8(a).

### BEST MODE FOR CARRYING OUT THE INVENTION

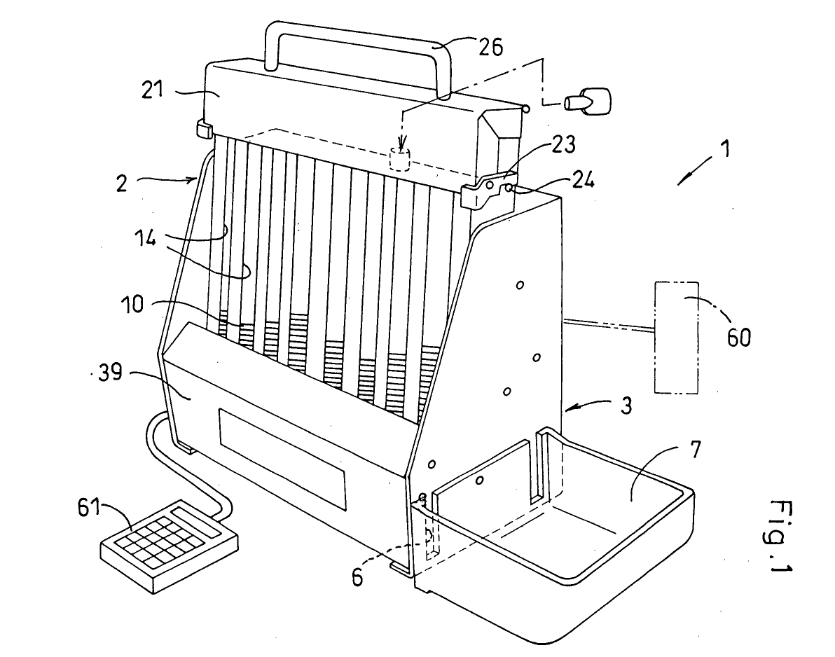

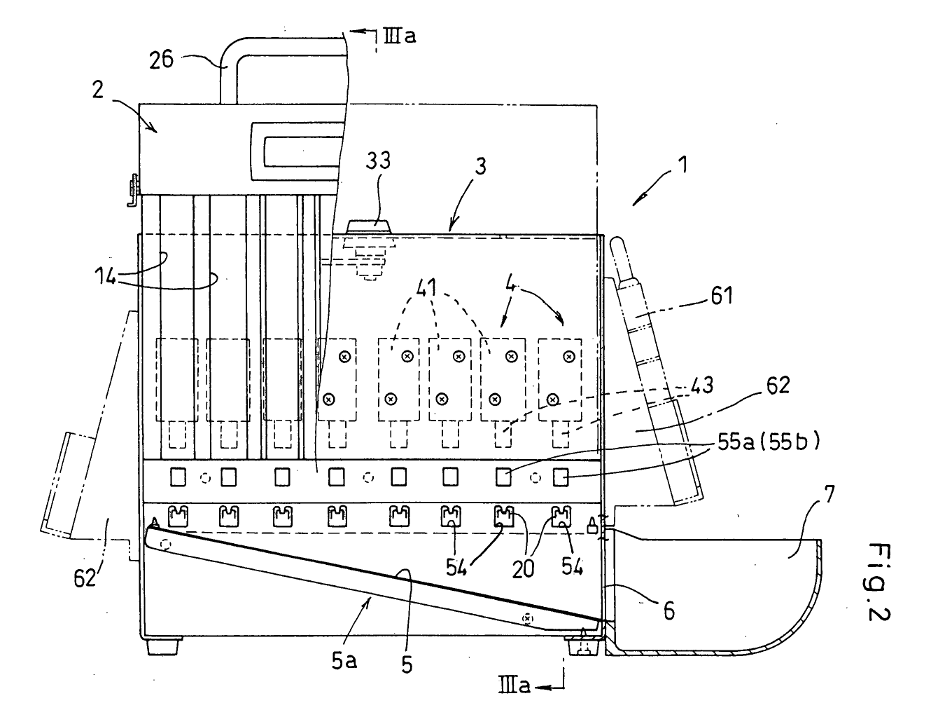

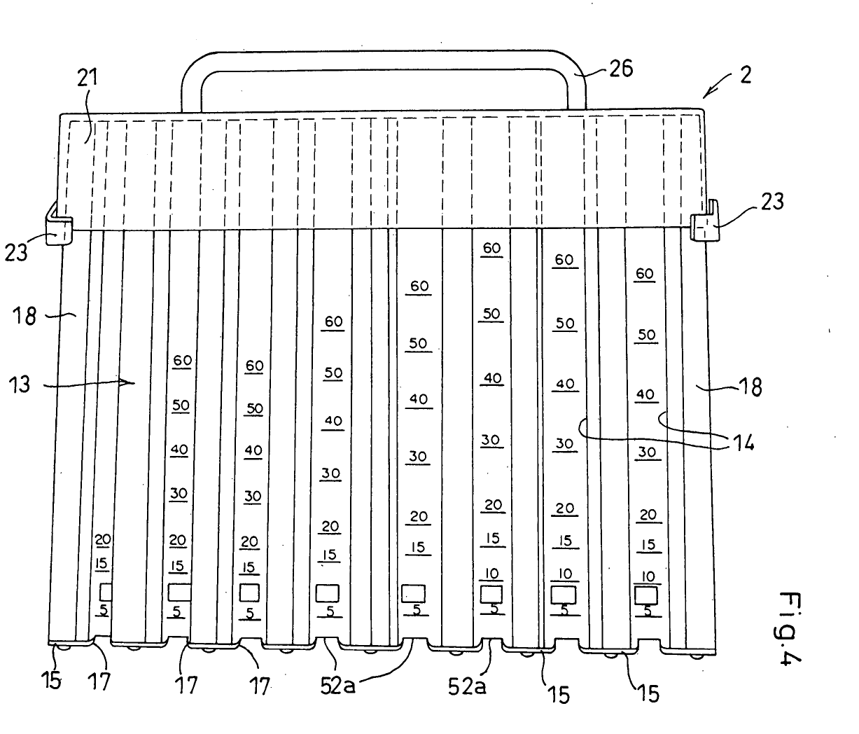

Next, with reference to FIG. 1 through FIG. 8, description will be made for a preferred embodiment of the coin dispenser according to the present invention. As shown in FIG. 1, a coin dispenser 1 includes a coin stacker 2 capable of holding stacks of coins 10 by the kind, and a main case 3 which has a front face for detachable mounting of the coin stacker 2 and incorporates a dispensing mechanism 4. The main case 3 has a front lower portion, near which there is provided a shoot 5 (See FIG. 2) for discharging the coins 10 dispensed from a lower base of the coin stacker 2 by the dispensing mechanism, out of the dispenser. The main case 3 has a side surface formed with a discharge port 6 communicating with a lower end of the shoot 5. The discharge port 6 communicates with a dish-like coin sump 7 which is detachable or fixed.

First, the coin stacker 2 will be described. As shown in FIG. 1 through FIG. 6, the coin stacker 2 includes a metal or plastic column array 13 fixed with e.g. screws to a frame 9 which is formed by a pair of left and right side plates 18 made of metal, an upper rear plate 19 and a metal base member 12 having a shape of L as viewed from a side. The column array 13 includes a plurality of standing holder columns 14 each being generally tubular and capable of holding a column of coins of one kind stacked up horizontally. Each of the holder columns 14 has a front face formed with a longitudinal opening 14a.

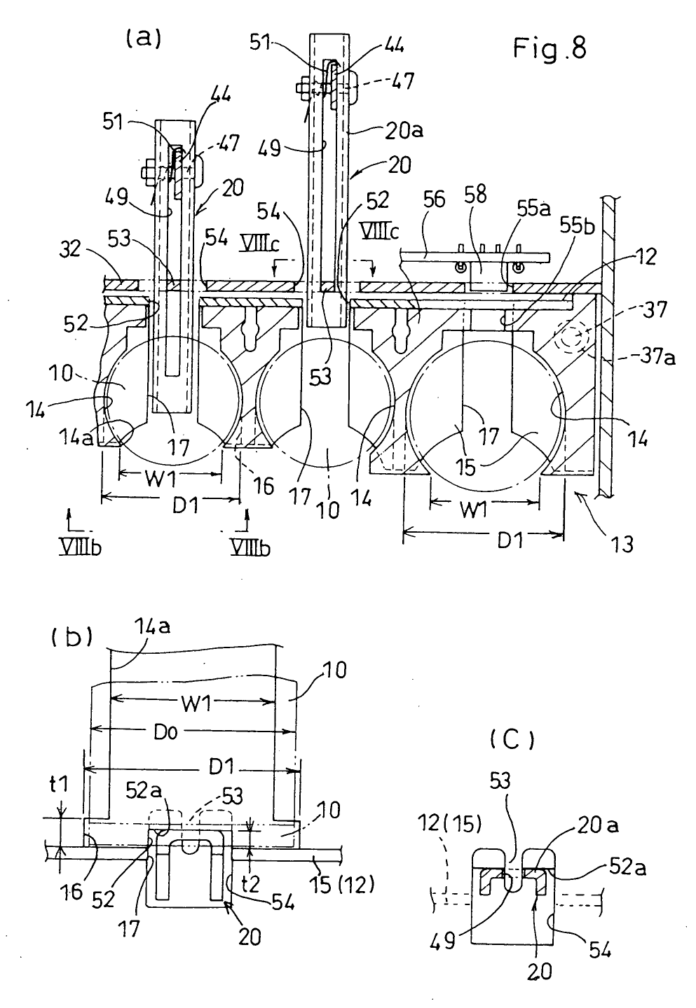

The opening 14a in each holder column 14 has a width W1 (See FIG. 8(a)) which is smaller than the diameter of the coins to be held inside. Each holder column 14 has an upper end opening from which the coins 10 can be filled. Further, each holder column 14 has a lower end, which is fixed and supported by a front-facing support 15 of the lower end of the base member 12, to support the lower surface of the coin 10 stacked in the holder columns 14. Each holder column 14 has a lower end formed with a pair of left and right dispensing grooves 16, 16 (See FIG. 8(b)) which provide an opening of: a diameter D1 which is slightly larger than a diameter D0 of the coins 10 held inside; and a height t0 which can be passed by only a coin 10a i.e. the lowest one of the stacked coins 10 held on the front-facing support 15, to be pushed through in the forward direction. Thus, the opening between the pair of dispensing grooves 16, 16 serves as an exit for the single coin 10a which is the lowest one of the horizontal stack of the coins 10.

In the present embodiment, the coins 10 to be dispensed are Euro coins (currency unit: Euro) according to the EC monetary union. The coins include eight kinds, namely, 0.01 Euro coin (16.25 mm diameter, 1.70 mm thickness), 0.02 Euro coin (18.75 mm diameter, 1.70 mm thickness), 0.05 Euro coin (21.25 mm diameter, 1.66 mm thickness), 0.10 Euro coin (19.75 mm diameter, 1.91 mm thickness), 0.20 Euro coin (22.25 mm diameter, 2.11 mm thickness), 0.50 Euro coin (24.25 mm diameter, 2.39 mm thickness), 1.00 Euro coin (23.25 mm diameter, 2.34 mm thickness), and 2.00 Euro coin (25.75 mm diameter, 2.20 mm thickness). For a reference, currency coins in Japan include 6 kinds, namely 1 yen, 50 yen, 5 yen, 100 yen, 10 yen and 500 yen in the increasing order of diameter. Thus, for the Japanese coins, the column array 13 will include six holder columns 14.

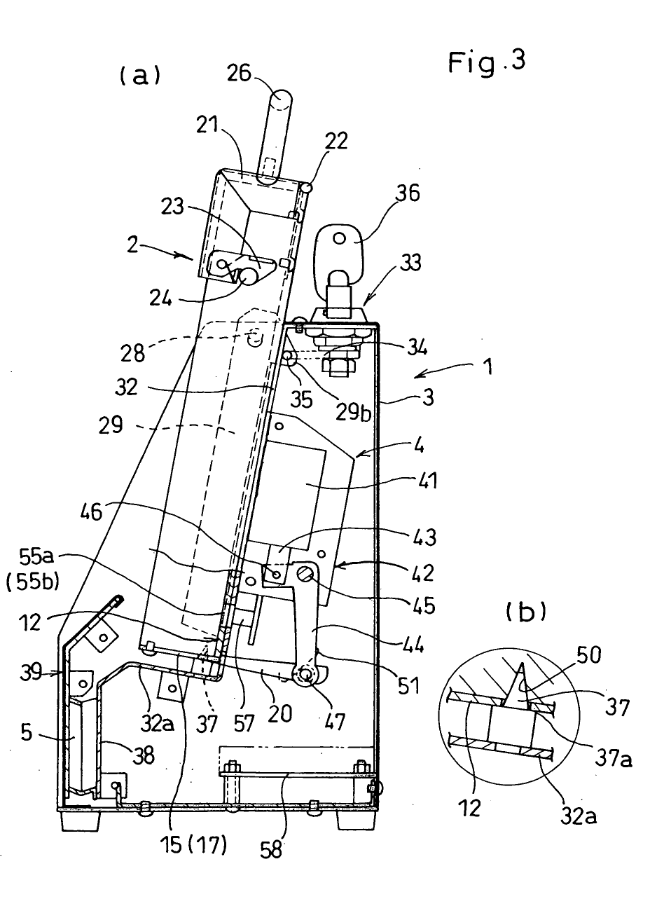

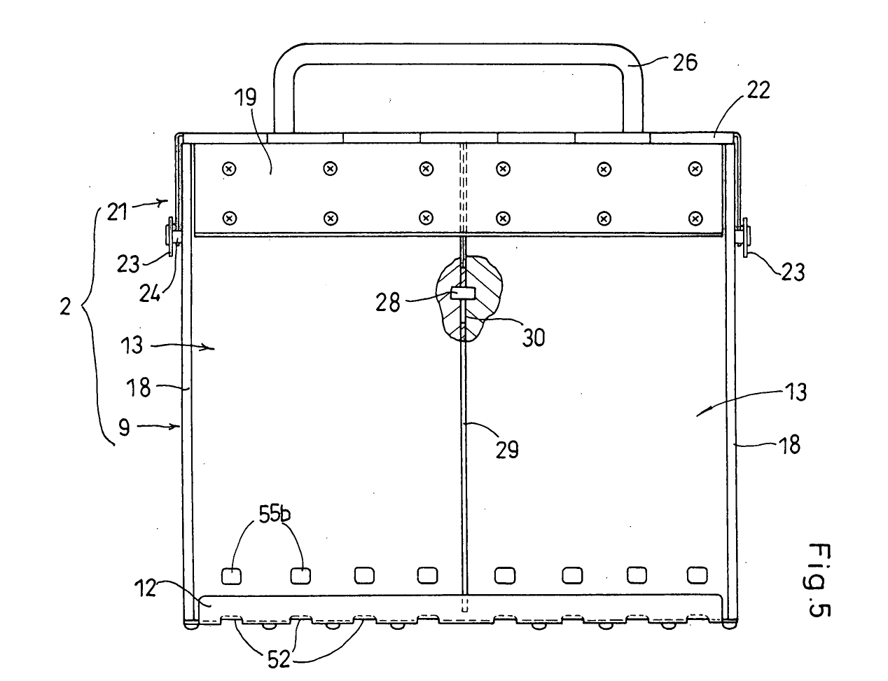

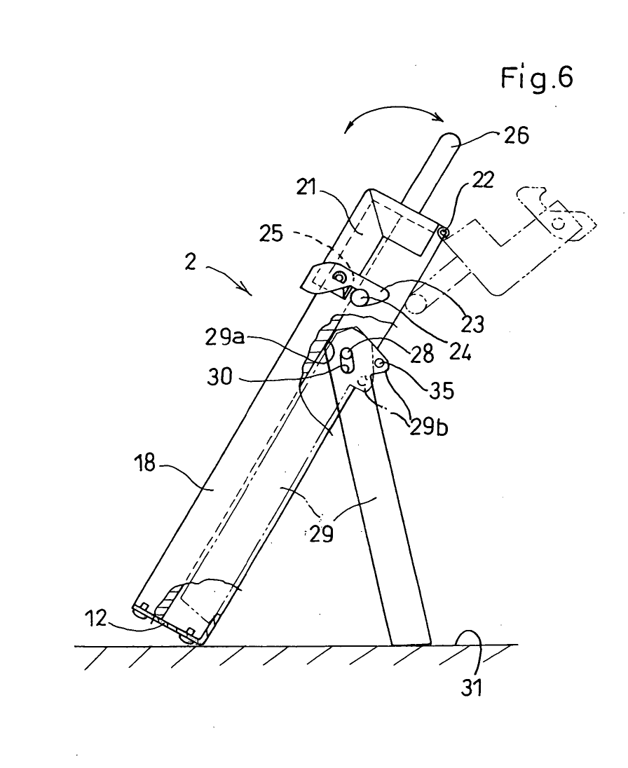

A passage 17 is formed at the front-facing support 15 and the lower base of the base member 12, extending in line with a diameter of the coins 10 so that a pusher 20 to be described later can move back and forth (See FIG. 8(a) and FIG. 8(b)). The upper rear plate 19 of the frame 9 has an upper end provided with a metal lid 21 to cover an upper portion of the column array 13, serving as a movable lid to the upper front face and the upper end openings (from which coins are filled) of all holder columns 14. The lid 21 can be opened and closed on a hinge 22, and is secured by a pair of hooks 23, each urged by a coil spring 25 in a direction of engagement with a pin 24 provided on the left and right sides of the frame 9 (See FIG. 1 and FIG. 3(a)). The lid 21 has an upper surface provided with a handle 26 so that the coin stacker 2 can be easily carried (See FIG. 5 and FIG. 6).

The coin stacker 2 allows easy refilling of the coins 10 since the holder columns 14 can be tilted back. Specifically, along a general center line which halves the column array 13 into left and right sides, there is formed a vertical sheath groove 27 opening on the rear surface of the coin stacker 2. The sheath groove 27 is fitted by a platy support 29 which has an upper end formed with a long hole 30. The long hole 30 is fitted by a pivot pin 28, making the platy support 29 pivotable. When pivoted out, the platy support 29 has its lower end coming out of the coin stacker 2, with a lower surface of the platy support 29 making contact with the table for example. The platy-support 29 has a slanted upper front surface 29a, which makes contact to a bottom surface of the sheath groove 27, to prevent the pivoting angle from becoming greater. Thus, as shown in FIG. 6, the front surface of the coin stacker 2 is tilted rearward. When the platy support 29 is raised so that the pivot pin 28 comes in the lower end of the long hole 30, the platy support 29 can be moved back in parallel to the sheath groove 27. In this state, the lower end of the platy support 29 makes contact with an inside surface of the base member 12, and the platy support 29 will not come out.

The main case 3 has a front face provided with a support plate 32 which is tilted-back so its upper portion is farther away from the front. The support plate 32 has a lower portion extended to a forwardly bent portion 32a and then to a front wall plate 38 which goes downward. Between this wall plate 38 and a front cover member 39, there is fixed a slider 5a which is a plate of metal providing the shoot 5 for the coins 10 to be discharged (See FIG. 2 and FIG. 3(a)). The forwardly bent portion 32a has an upper surface, with a left and a right sides each provided with a conical positioner 37 (See FIG. 2 and FIG. 3(b)). Correspondingly, the coin stacker 2 has a lower surface, with a left and a right ends each formed with a fitting hole 50. When a base 37a of each positioner 37 is contacted by the lower surface of the base member 12, the coin stacker 2 is at a predetermined position laterally and vertically.

When the coin stacker 2 is mounted on the front face of the main case 3, an upper projection 29b of the platy support 29 fits into a vertical groove (not illustrated) in a support plate 32 of the main case 3. In addition, when a locking bolt 34 of a lock 33 is turned horizontally on the upper surface of the main case 3, thereby moving a tip of the locking bolt 34 to engage with a hole 35 in the projection 29b, the coin stacker 2 is integrated with the main case 3, and becomes non-removable (See FIG. 3(a)). The locking and unlocking operation is made with a key 36.

Next, the dispensing mechanism 4 in the main case 3 will be described. Between the support plate 32 of the main case 3 and a detachable rear cover 40, and behind each of the holder columns 14, there is disposed an electromagnetic solenoid 41 serving as an actuator in the dispensing mechanism 4, a link 42 connected with the electromagnetic solenoid 41, and the pusher 20 connected with the link 42 (See FIG. 2). The electromagnetic solenoid 41 is fixed to a back surface of the support plate 32 with screws for example, so that a plunger 43 of the electromagnetic solenoid 41 will travel up and down along the support plate 32. The link 42 includes a link member 44 which generally has a shape of an inverted L as viewed from a side, with an intermediate portion pivotably supported by a horizontal shaft 45 for pivotal movement in a vertical plane. Therefore, according to the embodiment, the horizontal shaft 45 which is held horizontally behind the support plate 32 supports the same number of the link members 44 as of the holder columns 14, each spaced by a predetermined distance from another.

The plunger 43 stays popped out of the electromagnetic solenoid 41 when electric signal (drive signal) is turned OFF. Each plunger 43 has an end to which a shorter arm of the link member 44 is pivotably connected with a pin 46. The longer arm of the link member 44 also has an end which is pivotably connected to a base of the pusher 20 with a pin 47. As shown in FIG. 8(a) through FIG. 8(c), the pusher 20 has a shape of an inverted U as viewed from a side, with its upper plate portion 20a being formed with a long longitudinal guide slit 49, and laid in the direction in which the coins 10 are to be pushed. The pusher 20 has a front end facing forward, through a guide hole 54 which serves as a guide in the support plate 32, and through the passage 17 in the base member 12 of the coin stacker 2.

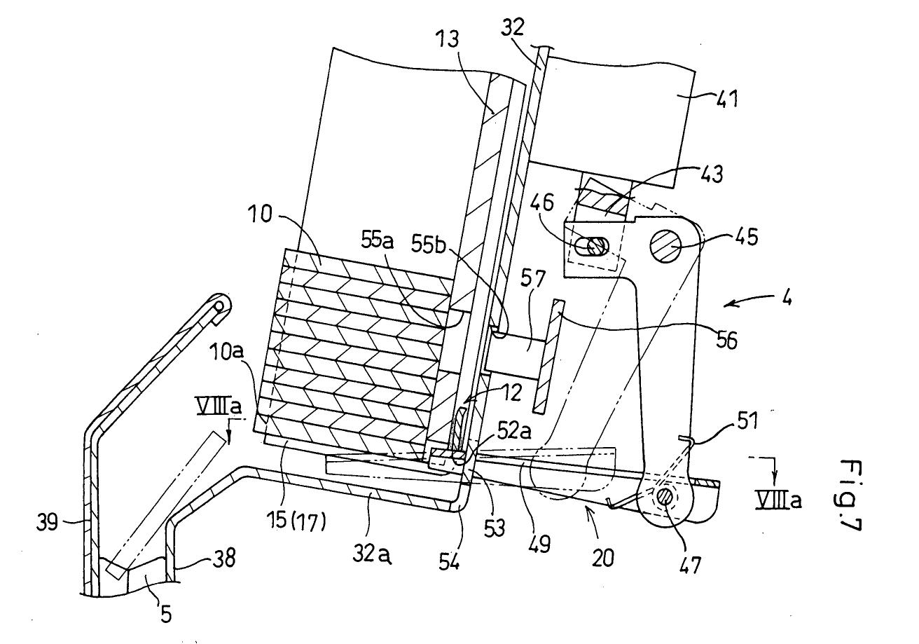

The pin 47 which connects the pusher 20 and the link member 44 is surrounded by a coil spring 51 serving as an urger. The coil spring 51 has an end engaged with a lower side of the pusher 20, while-another end of the coil spring 51 is engaged with a rear side of the link member 44. Thus, the pusher 20 is urged so that its front end portion makes contact with an upper surface of the guide hole 54 in the support plate 32 (See FIG. 7). With the contact of the front end upper surface of the pusher 20 with the upper surface of the guide hole 54, the urge causes the base end side of the pusher 20 to be urged upward. This urge causes the link member 44 to pivot counterclockwise as in FIG. 7, causing the tip of the plunger 43 to be pushed out. The guide hole 54 has an upper center portion integrally formed with a downward protruding guide projection 53. The downward protruding guide projection 53 fits in the guide slit 49 in the upper surface plate portion 20a of the pusher 20. It should be noted here that dimensional relationship between the height of the guide hole 54 and the projecting length of the downward protruding guide projection 53 is such that the lower end of the downward protruding guide projection 53 is not supported by the upper surface plate portion 20a yet the dimensions allow insertion of the front end of the pusher 20.

At the base of the base member 12 in the coin stacker 2 where the base meets the passage 17, there is formed a cutout or a regulating groove 52 (See FIG. 8(b)) which makes contact with the upper surface of the upper surface plate portion 20a of the pusher 20, thereby regulating the vertical position of the pusher 20 so that its front end is within a thickness of the coin 10 to be pushed out.

In other words, when manufacturing, it is simply necessary that a height dimension t2 from the upper surface of the front-facing support 15 in the base member 12 to an upper end plane 52a of the regulating groove 52 be made slightly lower than the thickness t1 which is the thickness of a single coin 10 to be held in the holder columns 14, in order to make sure that the upper surface plate portion 20a of the pusher 20 is always pressed downward by the upper end surface of the regulating groove 52 when the lower surface of the base member 12 in the coin stacker 2 is contacted to the base 37a (i.e. when the coin stacker is mounted), and further to make sure that the portion of the upper surface plate portion 20a including the front end of the pusher 20 is at the back of a single coin 10a residing on the front-facing support 15 of the base member 12 at the bottom of the stack, within the thickness range of the coin 10. This arrangement only requires that the front end side of the pusher 20 be upwardly urged by the coil spring 51 serving as the urger, and that the regulating groove 52 be given an accurate height dimension, in order to ensure that only the lowest one 10a of the stacked coins on the front-facing support 15 will be pushed by the pusher 20. This arrangement allows for a certain misalignment in the height and lateral positioning at the time of assembling the base member 12 to the column array 13 while ensuring that in no case two or more of the coins 10 will be pushed at a time.

Additionally, at a slightly higher position than the regulating groove 52 (at a height representing a stack of five to ten of the coins 10), a through holes 55a, 55b are provided which allow viewing through the support plate 32 and the back surface of the holder columns 14 in the column array 13. Together with this, reflective photo sensors 57 each including a light source and a light receiver are provided on a substrate 56 fixed to the back surface of the support plate 32. When the photo sensor 57 throws light and receives the light reflected by the stack of the coins 10 in each of the holder columns 14, the dispenser determines that there is enough stacks of the coins 10 for use as changes. On the other hand, when the thrown light passes through the above of the stack of coins 10 (i.e. when the sensor light receiver does not sense the reflection), the dispenser determines that there is a high possibility for an insufficient number of coins to be dispensed as changes. These determinations can be made by a controller whether it is an electronic substrate 58 which operates the electromagnetic solenoids incorporated in the main case 3 or a microcomputer incorporated in a casher 60 externally connected to the dispenser. A warning may be issued to a cash operator, or the controller may stop dispensing operation. Further, additionally, according to the present embodiment, the coin dispenser 1 according to the present invention is connected to a handy-type calculator 61 which accepts key entries of e.g. items sold, number of the items, and the amount of money received, then displays and/or prints out the items, numbers, subtotals, a total sales and changes and so on, and then operates the coin dispenser 1 to dispense a given amount of change consisting of a predetermined combination of the coins. The calculator 61 may be placed in a pocket 62 provided on an outer side of the main case 3.

When dispensing a change, upon reception of a command to dispense a change (coins 10), which specifies the number of coins to be dispensed for each kind, the electromagnetic solenoid(s) 41 corresponding to the specified holder column(s) 14 are turned ON and OFF the times equal to the number of the coins to be dispensed. When the electromagnetic solenoids are turned OFF, each plunger 43 comes lower by its own weight plus the urge from the coil spring 51, while the pusher 20 is held retracted, with its front end facing the back of the lowest coins 10a of the stack (See FIG. 7, illustration in solid lines).

When the electromagnetic solenoid 41 is turned ON, the plunger 43 is pulled up against the urge from the coil spring 51, the link member 44 rotates counterclockwise as in FIG. 7 by a predetermined degree, and the pusher 20 travels forward through the passage 17 in the front-facing support 15 (See FIG. 7, illustration in long dashed double-short dashed lines). During this movement, due to the pivotal action of the link member 44, the front end of the pusher 20 comes lower and tilted as the pusher 20 proceeds along the passage 17. A momentary action of the plunger 43 is expanded by the long arm of the link member 44, and translated into a quick forward travel (pushing action), in a long back-and-forth stroke. Thus, in an early part of the forward stroke, the pusher is released from the weight of the stacked coins 10, pushes the lowest coin 10a out of the stack, causing only the single coin 10a to go through the dispensing grooves 16 of the column array 13 and to drop into the shoot 5, so that the pushed coins 10 are collected in the coin sump 7.

It should be noted here that according to the embodiment shown in the drawings, the electromagnetic solenoids 41 are placed on the back side of the support plate 32 so that the plungers 43 are facing downward. Alternatively, placement may be made below the support plate 32 in the main case 3 so that the plungers 43 are facing upward.

Advantages of the present invention include compactness of the dispenser. As has been described, the actuator or the electromagnetic solenoid 41 is disposed on the back side of the support of 2 so that the plunger 43 travels in up and down directions. Compared to a case where a long actuator which covers all the travel distance by the plunger 43 are placed in parallel to the direction of pushing the coins 10, i.e. to the back-and-forth directions of the main case 3, the depth dimension of the main case 3 can be smaller, and the dispenser can be more compact. Further, the conversion of up-and-down actions of the plunger 43 into back-and-forth actions of the pusher 20 only requires a simple mechanism, and by selecting an appropriate length for the arms of the link member 44 in the dispensing mechanism 4, it is very easy to make the travel distance of the pusher 20 much greater than that of the plunger 43. These enable to use a smaller electromagnetic solenoid 41, which leads to simultaneous reduction in size and manufacturing cost.

Furthermore, since the dispensing mechanism 4 is provided with an urger (coil spring 51) which urges the plunger 43 in the pushing direction, the electromagnetic solenoid 41 should only retract the plunger when energized, i.e. the plunger 43 may not be forced out when the solenoid is turned OFF. This also enables reduction in manufacturing cost.

According to the present invention, the simple arrangement that the front end side of the pusher 20 is upwardly urged by the coil spring 51 serving as the urger and that the regulating groove 52 is made to an accurate height dimension makes easy an assembling operation of the pusher 20 while ensuring that only a single one of the coins 10 will be dispensed in the pushing action by the pusher 20. Another advantage is that the downward protruding guide projection 53 serving as a guide in the base portion of the base member 12, the guide slit 49 in the pusher 20 and the coil spring 51 serving as an urger which urges the front end side of the pusher 20 upwardly make sure the linear travel of the pusher 20.

1. A coin/token dispenser including: a main case having a front surface; a coin stacker detachably mounted to the front surface for holding a stack of coins; and a dispensing mechanism incorporated in the main case for dispensing the coins from a lower end of the coin stacker out of the dispenser through a shoot;
wherein the dispensing mechanism includes an actuator disposed on a back side of a support plate of the main case which supports a back surface of the coin stacker, the actuator moving in up-and-down directions along the support plate, moving a pusher generally along a lower base portion of the coin stacker, causing the pusher to push one of the coins out of the lower base portion of the coin stacker.

2. The dispenser according to claim 1, wherein the actuator is provided by an electromagnetic solenoid, the electromagnetic solenoid including a plunger moving generally in up-and-down directions along the support plate.

3. The dispenser according to claim 2, wherein the dispensing mechanism includes the pusher and a link connecting to the plunger of the electromagnetic solenoid, the pusher being movable back and forth along a guide formed in the support plate, the link having an intermediate portion pivotably supported by a horizontal shaft.

4. The dispenser according to claim 2, wherein the dispensing mechanism fiercer includes an urger for urging the plunger in a protruding direction.

5. The dispenser according to claim 2, wherein the lower base portion of the coin stacker has a passage for the pusher to travel through, and a regulator regulating a vertical position of the pusher.

6. The dispenser according to claim 5, wherein the urger urges the pusher onto the regulator.

7. The dispenser according to claim 1, wherein the coin stacker includes an array of holder columns each for holding a stack of coins of one kind, each of the holder columns being provided with a set of the electromagnetic solenoid and the dispensing mechanism along the array.

8. The dispenser according to claim 7, wherein the main case is internally provided with a reflective photo sensor arranged adjacent to the lower base portion of the coin stacker for detecting presence or absence of the stack of coins with respect to each of the holder columns.
